(19) United States
(12) Patent Application Publication
(10) Pub. No.: US 2018/0188513 A1
(43) Pub. Date: Jul. 5, 2018

(54) CENTERED CONDENSER LENS IN THE MIDDLE OF A BIGGER ROUND, CARVED LENS, WITH OPEN TUNNELS LIGHTED WITH LIGHTS OR LASER LIGHTS REACHING THE CIRCUMFERENCE OF THE SMALLER CONDENSER LENS

(71) Applicant: CHRISTINA MARIA ARRAYA, MISSISSAUGA (CA)

(72) Inventor: CHRISTINA MARIA ARRAYA, MISSISSAUGA (CA)

(21) Appl. No.: 15/732,112

(22) PCT Filed: Mar. 24, 2016
(86) PCT No.: PCT/CA2016/000103

§ 371 Date: Sep. 25, 2017

(30) Foreign Application Priority Data
Mar. 25, 2015 (CA) 2,886,069

(51) Int. Cl. G02B 19/00; F21V 5/04; G02B 3/12

(52) U.S. Cl. CPC G02B 19/0009; G02B 3/12; F21V 5/04

(57) ABSTRACT

A condenser lens, solid, or filled with oil, liquid, water, emply, gel, gel or any liquid to freeze it to ice, centered in the middle of a bigger, round, circular, positive lens, negative lens, regular lens, flat lens, window lens, mirror lens, glass lens; any transparent material lens; with eight, and twelve carved open tunnels lighted with regular light, laser light, laser beam, led light, facing the tunnels to go through, reaching the smaller condenser lens, covering the circumference of the condenser lens with light to make different reaction including magnify any object; the laser light or any light traveling from the entrance of each border of the edge of the eight, and twelve tunnels of the round lense to the centered smaller condenser lense.

The Centered Condenser lens in the middle of a bigger round, carved lens, are the two components, that they must be implemented together in relationship between them.

A condenser lens, solid, or filled with oil, liquid, water, empty, gel or gel or any liquid to freeze it to ice, centered in the middle of a bigger, round, circular, positive lens, negative lens, regular lens, flat lens, window lens, mirror lens, glass lens, any transparent material lens, with eight and twelve carved open tunnels lighted with regular light, laser lights or laser beam, led lights, facing the tunnels to go through, reaching the smaller condenser lens, covering the circumference of the condenser lens with light to make different reaction including magnify any object; the laser light or any light traveling from the entrance of each border of the edge of the eight and twelve tunnels of the round lense to the centered smaller condenser lens.

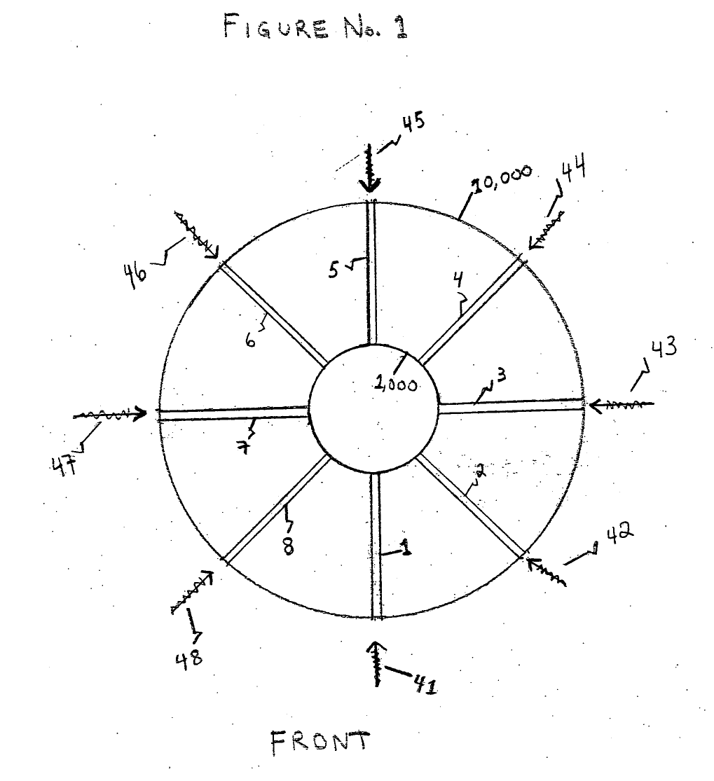

FIG. 1: A condenser lens in the middle of a bigger round, carved lens with eight open tunnels, singular optics system:

FIG. 1, a condenser lens, solid, or filled with oil, liquid, water, empty, gel, gel or any liquid to freeze it to ice, Number: 1000 centered in the middle of a round carved lens; positive lens, negative lens, regular lens, flat lens, window lens, mirrow lens, glass lens, transparent material lens; Number: 10,000 with eight open tunnels Numbers: 1, 2, 3, 4, 5, 6, 7, and 8 beside each other are the two components, that must be implemented together in relationship between them, as an optics system; four diagonals open tunnels Numbers: 2, 4, 6, 8 and four perpendiculars open tunnels Numbers: 1, 3, 5, 7; with a plurality of independent eight laser beams, or led light regular light or any light, facing in each of the eight open tunnels of the caraved lens Number: 41, 42, 43, 44, 45, 46, 47, 48.

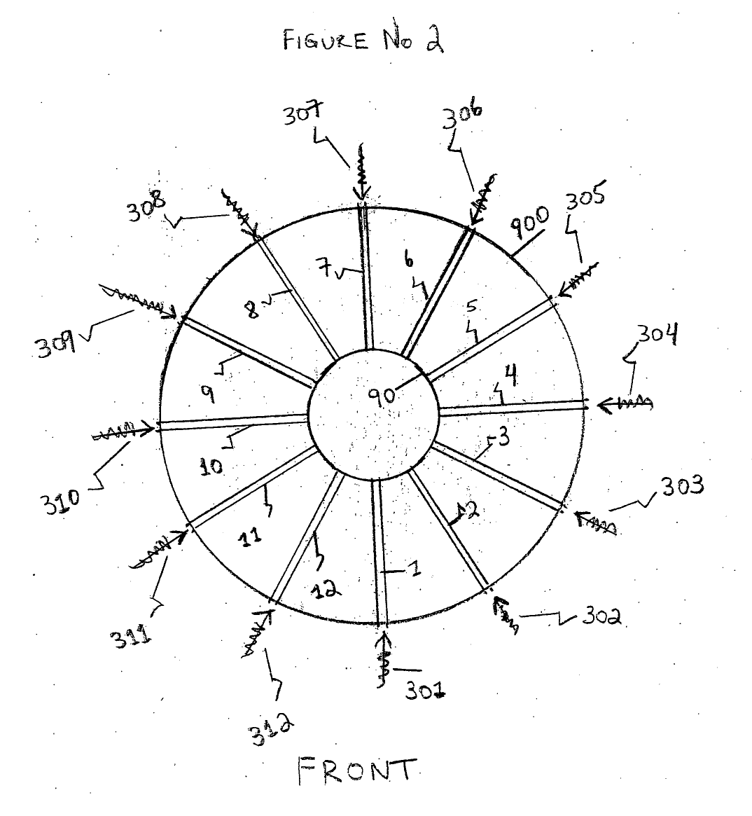

FIG. 2: A condenser lens in the middle of a bigger round, carved lens with twelve open tunnels, singular optics system:

FIG. 2, a condenser lens, solid or filled with oil, liquid, water, empty, gel, gel or any liquid to freeze it to ice, Number: 90 centered in the middle of a round carved lens; positive lens, negative lens, regular lens, flat lens, window lens, mirrow lens, glass lens, transparent material lens; Number: 900 with twelve open tunnels Numbers: 1, 2, 3, 4, 5, 6, 7, 8, 9, 10, 11, and 12 beside each other are the two components, that must be implemented together in relationship between them, as an optics system; eight diagonals open tunnels Numbers: 2, 3, 5, 6, 8, 9, 11, 12 and four perpendiculars open tunnels Numbers: 1, 4, 7, 10; with a plurality of independent twelve laser beams, or led light, regular light or any light, facing in each of the twelve open tunnels of the carved lens Number: 301, 302, 303, 304, 305, 306, 307, 308, 309, 310, 311, 312.

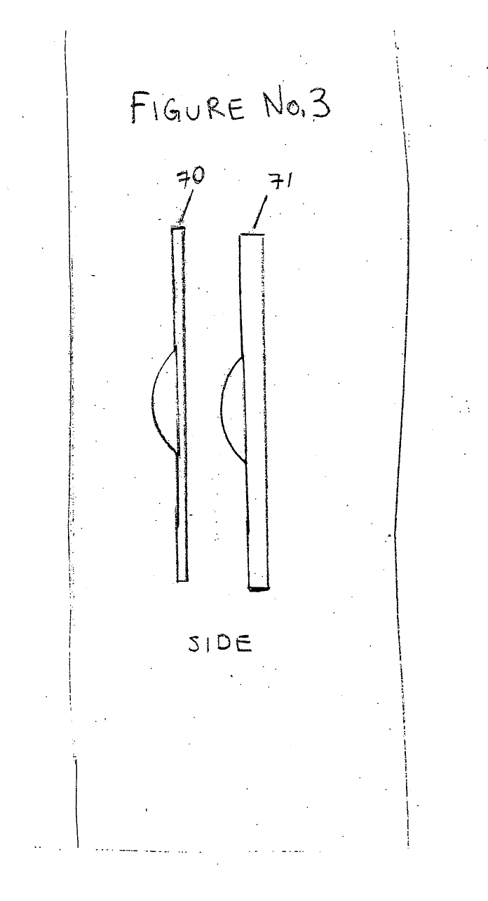

FIG. 3: A condenser lens in the middle of a bigger round, carved lens, with open tunnels, optics system:

FIG. 3, Numbers: 70 and 71 a condenser lens in the middle of a round carved lens with eight and twelve tunnels are a part of a singular; and plurality of compounds lenses with a combination of two, three, four or more lenses forming as an independently mounted unit.

This optical property system are designated to work for universal general use, and also, such as lenses, lights and lasers with different colors, laser lights, beams of lights also with different colours, led lights, illumination, microscope, telescope and optical devices in general, also photography, television, computers, cellular phones, movies, shows, are prevalent to the use of any of this optical structure.

Large distribution of light are transmitted into the condenser lens, absorbing great volume of concentrating light energy and transmitted into the designate area for the particular use of the optical structure.

Solid condenser lens, absorbing energy light. Condenser lens filled with oil, absorbing energy light. Condenser lens filled with liquid, water, absorbing energy light. Condenser lens filled with gel or empty, absorbing energy light.

This optical structure are round lenses that has a distribution of eight and twelve open tunnels, designated as a passageway for the light to travel through to reach the circumference of the centered condenser lens. Each straight vertical, horizontal an diagonal open tunnels lines reaches the centered condenser lens traveling the entire circumference making three solid lights in the same axis from the circumference.

The eight open tunnels makes three solid lights in the same axis from the circumference of the centered condenser lens.

The twelve open tunnels makes four solid light in the same axis from the circumference of the centered condenser lense.

This set of lenses are a part of a singular or compound lenses with a combination of two, three, four or more sets of lenses forming an independently mounted unit.

The vertical and horizontal open tunnels straight lines are negative, and the diagonal open tunnels straight lines are positive. The left side of the condenser circumference lens is negative and the right side of the condenser circumference lens is positive.

It is necessary for the light to travel in negative and positive straight line, to be able to bend the light in the circumference, usually bending to the right side, having the light in a complete circle making it negative and positive. Light do not have negative and positive, and when they meet in the circumference, as negative and positive, they have to separate from the material that is making the light to become negative and positive, and becomes nanometer, or angstrom light.

If the light has only a cross vertical and horizontal, it is necessary to a fast move the mounted object to the right ones and bring it back to the correct position, to have a contact with this vertical and horizontal to make it diagonal, and also the light has to have a negative horizontal or vertical with a positive diagonal to be able to work.

The circumference is 3.14 that is our system, when becomes more than 3.14 to 4.00 it becomes nanometer or angstrom, with steamily high speed that can not fit in our system. As humans this is difficult to understand because it is not our nature, the way we understand would be in sizes, like an entire solid watermelon can not fit inside a small class with water, and the speed more 3.14 to 4.00 can not fit in our system, it repels to each other.

The speed of light and sound that enters in our system is according to our system, but its nature it is higher, faster in the nanometer and angstrom system that can not enter or fit in our system.

The speed also changes the time, the faster is the speed, shorter is the time. If we travel by plane, we arrive in shorter time than traveling by car.

The circumference is energy, specially when it is in motion, four small car wheels, can carry an entire car, with many people, luggage, the weight of the car itself, with much higher weight and size of the wheels, even when the car is park, the circumference is part of our energy system and does not change from 3.14

The wheel is round with spokes and a hub—like a nucleus in the center.

This optical structure system has a round lens, with carved open tunnels, and a smaller condenser lens—like a nucleus in the center

This optical structure system, creates its own energy with the open tunnels of the round lens, using light to creates its natural nanometer speed, higher than 3.14 even if it is not in motion, using the circumference of the centered condenser lens that is a part of our energy system, and bending the light into a complete circumference system, which 3.14 becomes higher, from 3.14 between 4.00

Straight line (negative), parallel straight lines (negatives), and straight lines adjacent with diagonal straight lines (positive), belongs in the nanometer system, curve lines and circumference belongs in our system. This is a pattern to see from where they came from.

It helps to distinguish the symmetry of virus, bacteria, and many other areas.

What is claimed is:

1. A condenser lens in the middle of a bigger round, carved lens, with open tunnels, optics system.

2. The condenser lens in the middle of a bigger round, carved lens, with open tunnels, optics system:
A round carved positive lens, with open tunnels;
A round carved negative lens, with open tunnels;
A round carved regular lens, with open tunnels;
A round carved flat lens, with open tunnels;
A round carved window lens, with open tunnels;
A round carved mirrow lens, with open tunnels; and
A round carved glass lens, with open tunnels.

3. The condenser lens in the middle of a bigger round, carved lens, with open tunnels, optics system of claim 1. wherein the centered condenser lens in the middle of a bigger round, carved lens, with open tunnels are the two components, that must be implemented together in relationship between them, as an optics system.

4. The condenser lens in the middle of a bigger round, carved lens, with open tunnels, optics system:
A round carved lens, with eight open tunnels, beside each other.

5. The condenser lens in the middle of a bigger round, carved lens, with open tunnels optics system:
A round carved lens, with twelve open tunnels, beside each other.

6. The condenser lens in the middle of a bigger round, carved lens, with open tunnels, optics system:
A condenser transparent material lens in the middle of a bigger round, carved transparent material lens, with eight open tunnels; and
A condenser transparent material lens in the middle of a bigger round, carved transparent material lens, with twelve open tunnels.

7. The condenser lens in the middle of a bigger round, carved lens, with open tunnels, optics system of claim 4, wherein said with four diagonals open tunnels and four perpendicular open tunnels, beside each other.

8. The condenser lens in the middle of a bigger round, carved lens, with open tunnels, optics system of claim 5, wherein said with eight diagonal open tunnels and four perpendicular open tunnels, beside each other.

9. The condenser lens in the middle of a bigger round, carved lens, with open tunnels, optics system:
A plurality independent eight laser beam lights in each eight open tunnels of the carved lens.

10. The condenser lens in the middle of a bigger round, carved lens, with open tunnels, optics system:
A plurality independent twelve laser beam lights in each twelve open tunnels of the carved lens.

11. The condenser lens in the middle of a bigger round, carved lens, with open tunnels, optics system of claims 4, 9, wherein the centered condenser lens in the middle of a bigger round, carved lens, with eight open tunnels with the plurality independent laser beam lights in each of the eight open tunnels of the carved lens, are the components, that must be implemented together in relationship between them.

12. The condenser lens in the middle of a bigger round, carved lens, with open tunnels, optics system of claims 3, 4, 5, wherein said plurality the lenses are a part of a singular, plurality of compound lenses with a combination of two, three, four or more lenses forming as an independently mounted unit.

13. The condenser lens in the middle of a bigger round, carved lens, with open tunnels, optics system of claims 5, 10, wherein the centered condenser lens in the middle of a bigger round, carved lens, with twelve open tunnels with the plurality independent laser beam lights in each of the twelve open tunnels of the carved lens, are the components, that must be implemented together in relationship between them.

14. The condenser lens in the middle of a bigger round, carved lens, with open tunnels, optics system of claims 4,9, wherein said are the components, that must be implemented together in relationship between them, making a complete plurality two circles of light around the circumference of the condenser lens in the same circle, by absorving the lights of the each eight tunnels of the bigger round lens.

15. The condenser lens in the middle of a bigger round, carved lens, with open tunnels, optics system of claims 5,10, wherein said are the components, that must be implemented together in relationship between them, making a complete plurality three circles of light around the circumference of the lens in the same circle, by absorbing the lights of the each twelve open tunnels of the bigger round lens.

16. The condenser lens in the middle of a bigger round, carved lens, with open tunnels, system of claims 14,15, wherein said the plurality of independent laser beam lights, or any lights located from the inside entrance of each border of the edge of each of the eight open tunnels, each of the twelve open tunnels of the round lens, passing each tunnel to the centered smaller condenser lens, bending the light on its own, in curvature manner around the circumference of the condenser lens.

17. The condenser lens in the middle of a bigger round, carved lens, with open tunnels, optics system:
A condenser filled with oil lens in the middle of a bigger round carved lens, open tunnels, with plurality of laser beam; and
A condenser filled with ice liquid lens in the middle of a bigger round, carved lens, open tunnels with plurality of laser beam.

18. The condenser lens in the middle of a bigger round, carved lens, with open tunnels, optics system of claim 17, wherein said the condenser filled with ice liquid lens in the middle of a bigger round, carved lens, open tunnels with plurality of laser beam, is located, also behind the condenser filled with oil lens in the middle of a bigger round, carved lens, open tunnels with plurality of laser beam, to cool the optical system.

19. The condenser lens in the middle of a bigger round, carved lens, with open tunnels, optics system:
A condenser filled with ice water lens in the middle of a bigger round, carved lens, open tunnels, with plurality of laser beam.

20. The condenser lens in the middle of a bigger round, carved lens, with open tunnels, optics system of claim 19, wherein said the condenser filled with ice water lens in the middle of a bigger round, carved lens, open tunnels, with plurality of laser beam is in variant locations, also in the back, or in the front of the optical system to refresh the optical system and the atmosphere.

21. The condenser lens in the middle of a bigger round, carved lens, with open tunnels, optics system:
A condenser filled with gel lens in the middle of a bigger round, carved lens, open tunnels, with plurality of laser beams; and
A condenser empty lens in the middle of a bigger round, carved lens, open tunnels, with plurality of laser beams.

22. The condenser lens in the middle of a bigger round, carved lens, with open tunnels, optics system:
A plurality independent regular lights located in each of the eight tunnels of the carved lens;
A plurality independent regular lights located in each of the twelve tunnels of the carved lens;
A plurality independent different variant of color lights located in each of the eight tunnels of the carved lens; and
A plurality independent different variant of color lights located in each of the twelve tunnels of the carved lens.

23. The condenser lens in the middle of a bigger round, carved lens, with open tunnels, optics system of claim 22, wherein said the independent laser beam light, any light, the different color light, located inside the border of each of the eight open tunnels of the bigger round lens.

24. The condenser lens in the middle of a bigger round, carved lens, with open tunnels, optics system of claim 22, wherein said the independent laser beam light, any light, the different color light, located inside the border of each of the twelve open tunnels of the bigger round lens.

25. The condenser lens in the middle of a bigger round, carved lens, with open tunnels, optics system of claim 2, wherein said this set of lenses are a part of a singular plurality of compound lenses with a combination of two, three, four or more set of lenses formed as an independently mounted unit.

26. The condenser lens in the middle of a bigger round, carved lens, with open tunnels, optics system of claim 9,10, wherein said the round carved lens, with twelve open tunnels, beside each other, with a centered condenser lens in the middle, is located at the back or in the front of the round carved lens, with eight open tunnels, beside each other with a centered condenser lens in the middle; illuminating each other with a radiant energy light.
